(19) United States
(12) Patent Application Publication
(10) Pub. No.: US 2026/0233781 A1
(43) Pub. Date: Aug. 13, 2026

(54) VEHICLE STRUCTURE

(71) Applicant: Honda Motor Co., Ltd., Tokyo (JP)

(72) Inventor: Taku WATANABE, Tokyo (JP)

(73) Assignee: Honda Motor Co., Ltd., Tokyo (JP)

(21) Appl. No.: 19/390,706

(22) Filed: Nov. 17, 2025

(30) Foreign Application Priority Data
Feb. 7, 2025 (CN) 202510137040.9

(51) Int. Cl. B62D 21/15

(52) U.S. Cl. CPC B62D 21/157

(57) ABSTRACT

Provided is a vehicle structure that may absorb impact loads and achieve good load transmission performance during side collision even when having a central channel extending along the vehicle length direction. The vehicle structure includes the following. A pair of side beams is provided. A channel component extends along the vehicle length direction and is disposed between the pair of side beams, and the vehicle structure forms a central channel extending along the vehicle length direction in the channel component. A cross beam extends along the vehicle width direction and is disposed between any one of the pair of side beams and the channel component. Also, a reinforcing component extends along the vehicle width direction, is disposed on the inner side of the channel component in the vehicle width direction, and is at a position overlapping with the cross beam in the vehicle height direction.

### CROSS-REFERENCE TO RELATED APPLICATION

This application claims the priority benefit of China application serial no. 202510137040.9, filed on February 7, 2025. The entirety of the above-mentioned patent application is hereby incorporated by reference herein and made a part of this specification.

### BACKGROUND

### Technical Field

The disclosure relates to a vehicle structure.

### Related Art

In recent years, efforts to provide access to sustainable transportation systems that also consider vulnerable road users such as elderly people, disabled people, or children among traffic participants are becoming active. To achieve this purpose, research and development are being conducted to further improve traffic safety and convenience through development related to collision safety performance.

In the related art, Patent Literature 1 (Japanese Patent Publication No. 7339565) provides a vehicle body lower structure that does not require a battery case for supporting a battery from below by disposing the battery between a pair of side beams extending in the front-rear direction and suspending and fixing the battery to a floor and cross beam of the vehicle body lower structure. However, in Patent Literature 1, the vehicle body lower structure absorbs collision load through energy absorbing components extending in the left-right direction on cross-sections of side beams extending in the front-rear direction, and absorbs collision energy through collapse of the energy absorbing components. However, in a structure where cross beams connect a pair of side beams in a straight line and the cross beams are divided into left and right portions at a central channel, the cross beams become shorter and there is a problem of deterioration in load transmission efficiency caused by the central channel. Therefore, how to effectively transmit load during collision is a problem yet to be solved.

The disclosure aims to solve the aforementioned problem to achieve improved collision safety performance, and furthermore, contributes to the development of sustainable transportation systems.

### SUMMARY

The disclosure provides a vehicle structure that may absorb impact loads and achieve good load transmission performance during side collision even when having a central channel extending along the vehicle length direction.

According to an embodiment of the disclosure, a vehicle structure includes the following. A pair of side beams is provided. A channel component extends along the vehicle length direction and is disposed between the pair of side beams, and the vehicle structure forms a central channel extending along the vehicle length direction in the channel component. A cross beam extends along the vehicle width direction and is disposed between any one of the pair of side beams and the channel component. Also, a reinforcing component extends along the vehicle width direction, is disposed on an inner side of the channel component in the vehicle width direction, and is at a position overlapping with the cross beam in the vehicle height direction.

Based on the above, in the embodiments of the disclosure, the vehicle structure has the cross beam and the reinforcing component disposed at overlapping positions in the vehicle height direction, the cross beam and the reinforcing component are each formed by extending in a manner of extrusion-formed along the vehicle width direction, therefore loads may be transmitted without deformation of the cross-sections of the cross beam and the reinforcing component to form a load path with good load transmission efficiency, thereby enabling better load transmission in the internal region of the vehicle structure, thus protecting the power unit installed between the side beams. Accordingly, even though the channel component of the vehicle structure forms a central channel and extends along the vehicle length direction, the channel component may not be easily flattened and deformed by laterally input loads like the side beams, but may absorb impact loads when a side collision occurs and transmit loads better in the internal region of the vehicle structure through the load transmission path formed through the disposition of the reinforcing component, the cross beam, and the channel component, thereby suppressing deformation caused by loads during side collisions.

To make the foregoing features and advantages of the disclosure more comprehensible, embodiments are specifically provided below and described in detail with accompanying drawings as follows.

### BRIEF DESCRIPTION OF THE DRAWINGS

FIG. 1 is a schematic diagram of a vehicle structure according to an embodiment of the disclosure.

FIG. 2 is a cross-sectional schematic diagram of the vehicle structure shown in FIG. 1 along a line A-A.

FIG. 3A is a partially enlarged schematic diagram of the vehicle structure shown in FIG. 2.

FIG. 3B is a partially enlarged schematic diagram of a vehicle structure according to another embodiment of the disclosure.

FIG. 4 is a cross-sectional schematic diagram of the vehicle structure shown in FIG. 1 along a line B-B.

FIG. 5 is a cross-sectional schematic diagram of the vehicle structure shown in FIG. 1 when a seat is installed.

FIG. 6 is a cross-sectional schematic diagram of the vehicle structure shown in FIG. 1 along a line C-C.

### DESCRIPTION OF THE EMBODIMENTS

In one embodiment of the disclosure, each of the pair of side beams, the cross beam, the channel component, and the reinforcing component is an extrusion-formed product, and the extrusion direction of each of the pair of side beams, the cross beam, the channel component, and the reinforcing component is the extension direction thereof.

In one embodiment of the disclosure, the pair of side beams extend along the vehicle length direction, a power unit is disposed between the pair of side beams, and the channel component is disposed above the power unit.

In one embodiment of the disclosure, the reinforcing component includes a reinforced component compartment divided by an upper surface and a lower surface of the reinforcing component extending along the vehicle width direction, the cross beam includes a cross beam compartment divided by any two of a rib in the cross beam and an upper surface and a lower surface of the cross beam extending along the vehicle width direction, the channel component includes a channel component compartment divided by a rib in the channel component, and the reinforced component compartment, the cross beam compartment, and the channel component compartment are aligned in the vehicle height direction.

In one embodiment of the disclosure, the channel component has a main body portion and an inner protrusion portion, the inner protrusion portion protrudes toward the inner side of the channel component in the vehicle width direction and is integrally disposed with the main body portion of the channel component, and the vehicle structure further has an inner connection portion disposed on the inner protrusion portion of the channel component and connected to the reinforcing component.

In one embodiment of the disclosure, a mounting hole is formed at a contact portion between the inner protrusion portion of the channel component and the reinforcing component, the inner connection portion fastens the inner protrusion portion of the channel component and the reinforcing component with a fastener in the vehicle height direction through the mounting hole.

In one embodiment of the disclosure, the channel component has a main body portion and an outer protrusion portion, the outer protrusion portion protrudes toward the cross beam and is integrally disposed with the main body portion of the channel component, the vehicle structure further has an outer connection portion, and the outer connection portion is disposed on the outer protrusion portion and connected to the cross beam.

In one embodiment of the disclosure, when viewed from a side, the upper surface of the cross beam has a front inclined surface extending forward and tilting downward.

In one embodiment of the disclosure, when viewed from a side, the cross beam has a rear inclined surface in a region rearward of the front inclined surface in the vehicle length direction, and the rear inclined surface extends rearward and tilts downward.

In one embodiment of the disclosure, the cross beam has a dimension in the vehicle length direction greater than a dimension in the vehicle height direction, and the reinforcing component has a length in the vehicle length direction that at least corresponds to the dimension of the cross beam in the vehicle length direction.

In one embodiment of the disclosure, the cross beam has a plurality of ribs connecting an upper surface and a lower surface of the cross beam, the reinforcing component has a plurality of ribs connecting an upper surface and a lower surface of the reinforcing component, and at least one of the ribs of the cross beam and at least one of the ribs of the reinforcing component are disposed at the same position in the vehicle length direction.

Reference will now be made in detail to exemplary embodiments of the disclosure, examples of which are illustrated in the accompanying drawings. Wherever possible, the same reference numerals will be used throughout the drawings and the description to refer to the same or like parts.

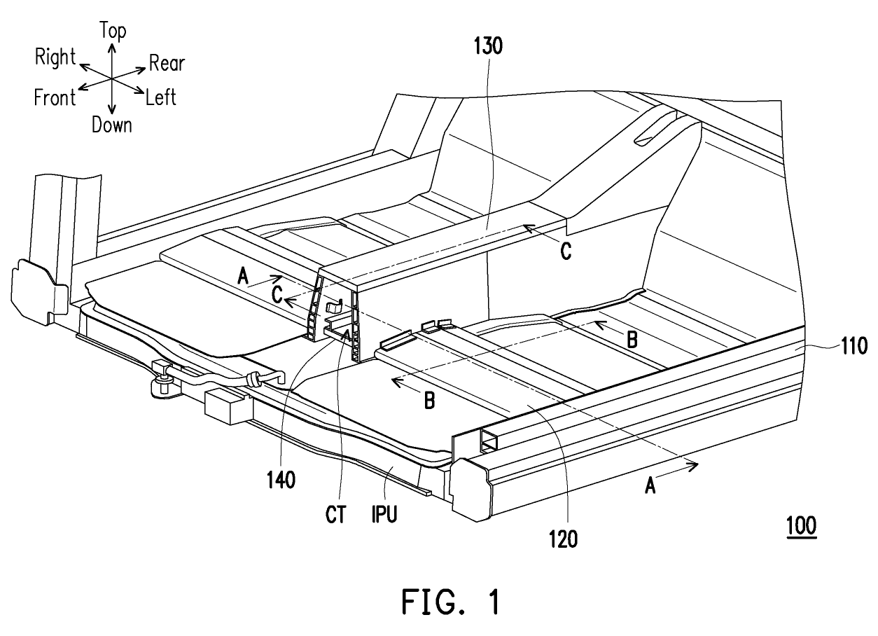

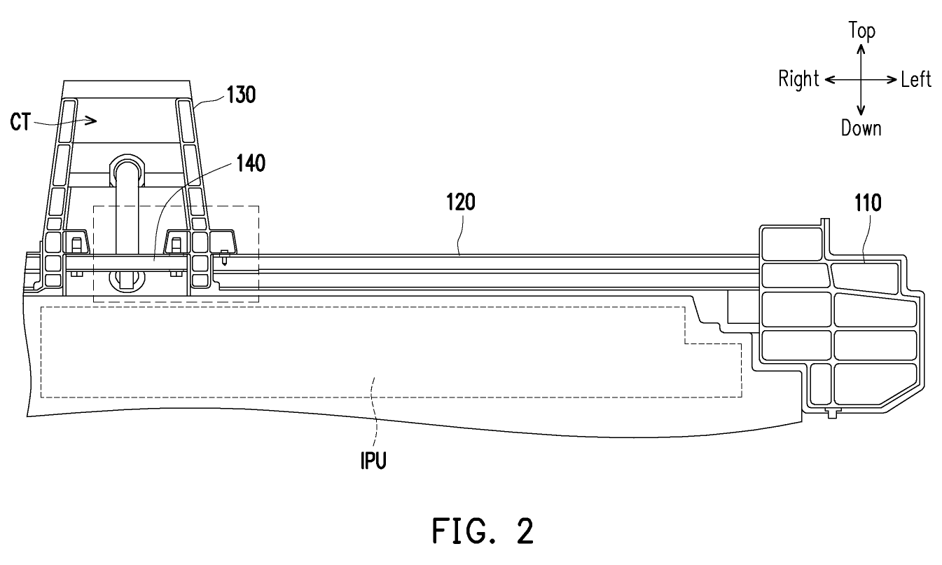

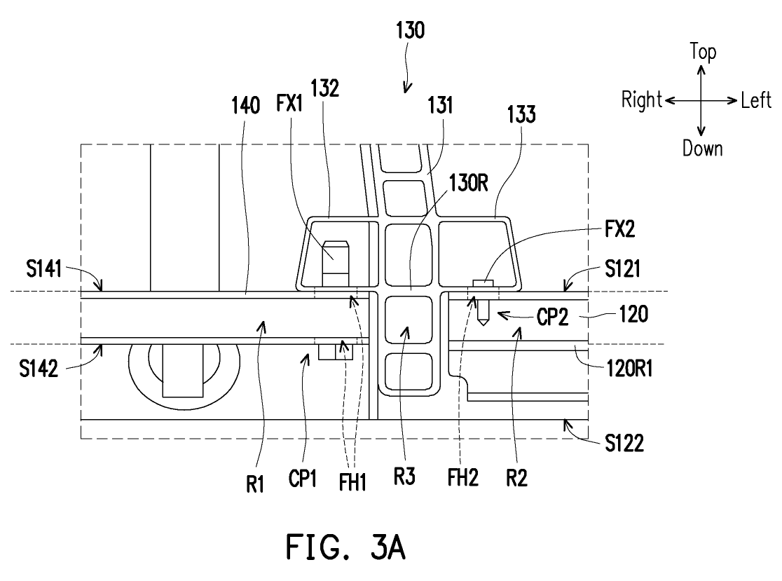

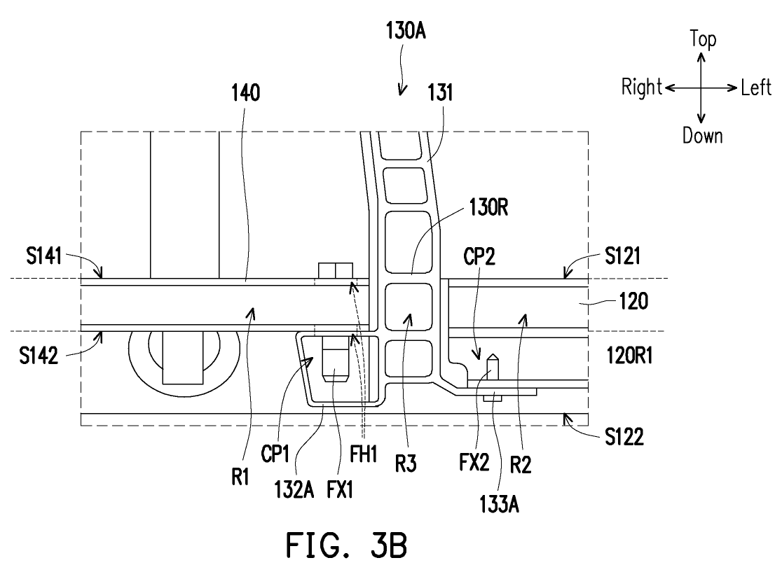

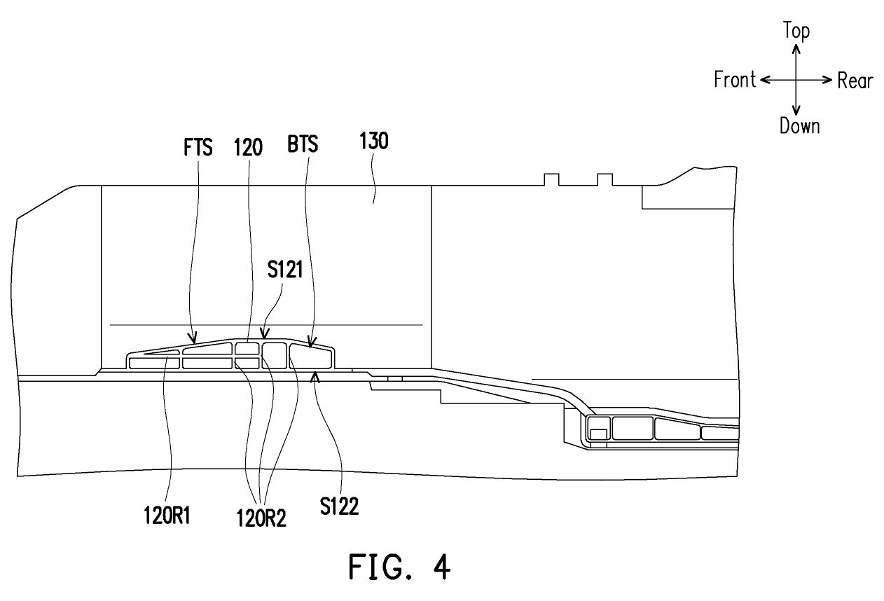

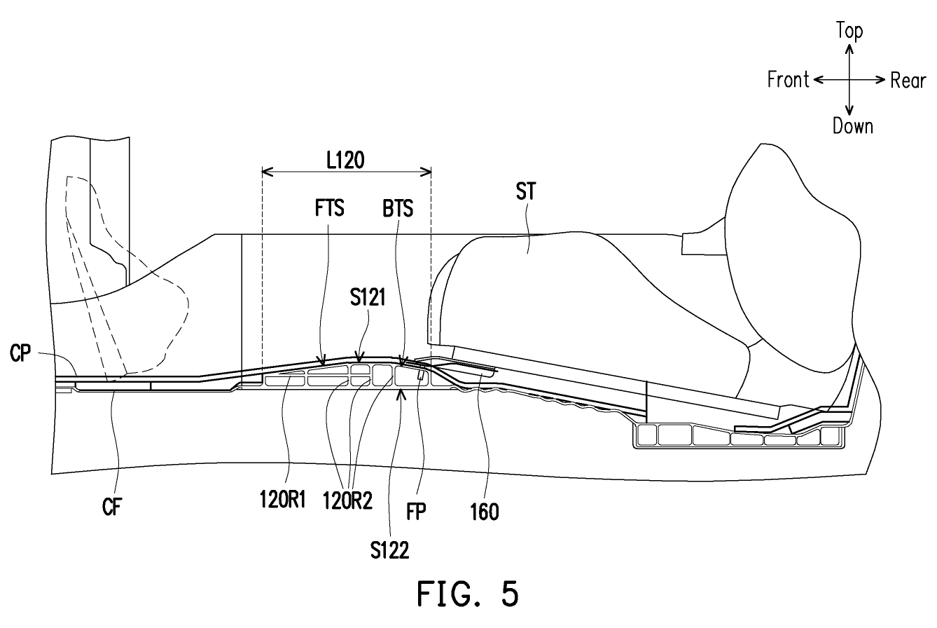

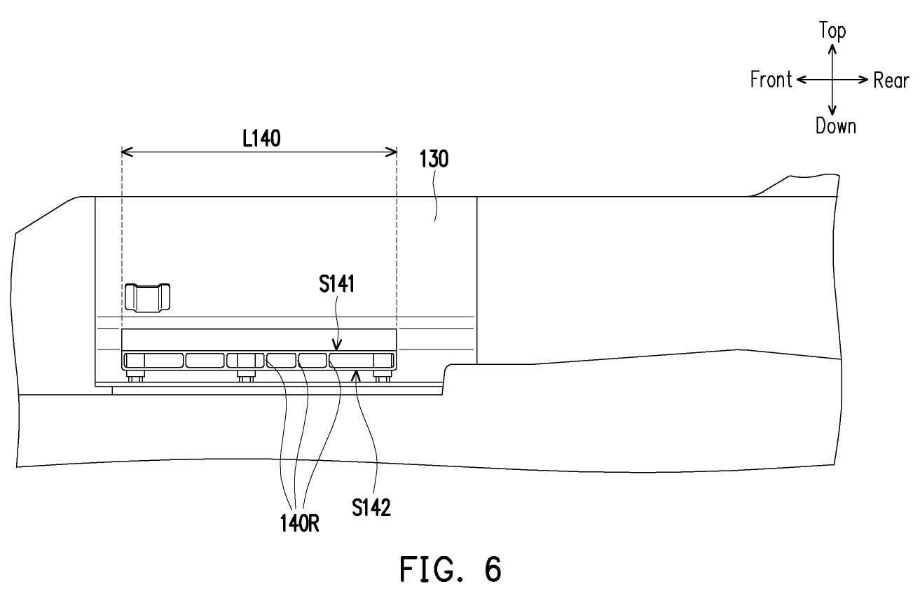

FIG. 1 is a schematic diagram of a vehicle structure according to an embodiment of the disclosure; FIG. 2 is a cross-sectional schematic diagram of the vehicle structure shown in FIG. 1 along a line A-A; FIG. 3A is a partially enlarged schematic diagram of the vehicle structure shown in FIG. 2; FIG. 3B is a partially enlarged schematic diagram of a vehicle structure according to another embodiment of the disclosure; FIG. 4 is a cross-sectional schematic diagram of the vehicle structure shown in FIG. 1 along a line B-B; FIG. 5 is a cross-sectional schematic diagram of the vehicle structure shown in FIG. 1 when a seat is installed; FIG. 6 is a cross-sectional schematic diagram of the vehicle structure shown in FIG. 1 along a line C-C. It should be noted that, for convenience, the front-rear direction, left-right direction, and top-down direction of the vehicle are defined as shown in the drawings, and the configuration of each portion is described according to this definition, in which the front-rear direction, left-right direction, and top-down direction of the vehicle correspond to the vehicle length direction, vehicle width direction, and vehicle height direction, respectively.

Referring to FIG. 1 and FIG. 2, in this embodiment, a vehicle structure 100 includes a pair of side beams 110, a cross beam 120, a channel component 130, a reinforcing component 140, and a power unit IPU. As shown in FIG. 1, the pair of side beams 110 and the channel component 130 respectively extend along the vehicle length direction, the channel component 130 is disposed between the pair of side beams 110, and the vehicle structure 100 forms a central channel CT extending along the vehicle length direction in the channel component 130. The cross beam 120 extends along the vehicle width direction and is disposed between any one of the pair of side beams 110 and the channel component 130. The reinforcing component 140 extends along the vehicle width direction, and as shown in FIG. 2, the reinforcing component 140 is disposed on the inner side of the channel component 130 in the vehicle width direction and at a position overlapping with the cross beam 120 in the vehicle height direction. In addition, as shown in FIG. 1 and FIG. 2, the power unit IPU is disposed between the pair of side beams 110, and the channel component 130 is disposed above the power unit IPU. Specifically, in this embodiment, the side beam 110, the cross beam 120, the channel component 130, and the reinforcing component 140 are all extrusion-formed products with high rigidity, and the extrusion direction of each component is the extension direction thereof.

Thus, by adjusting the extrusion-forming direction (that is, the extension direction of each component) of the components including the side beam 110, the cross beam 120, the channel component 130, and the reinforcing component 140 that are sequentially disposed from the outer side toward the inner side of the vehicle, the cross beam 120 and the reinforcing component 140 extend along the vehicle width direction, while the channel component 130 disposed between the cross beam 120 and the reinforcing component 140 extends along the vehicle length direction. It may be achieved that even a vehicle structure having a central channel CT can absorb impact load and transmit load when a side collision occurs. More specifically, in this embodiment, when a side collision load is input to the vehicle structure 100, through the side beam 110 disposed at the outermost side extending along the vehicle length direction, the cross-section of the side beam 110 may collapse and absorb the collision load, thus, the collision load may be absorbed by efficiently crushing the side beam 110, and since the cross beam 120 and the reinforcing component 140 are disposed at overlapping positions in the vehicle height direction, and the cross beam 120 and the reinforcing component 140 are each formed by extending in a manner of extrusion-formed along the vehicle width direction, loads may be transmitted without deformation of the cross-sections of the cross beam 120 and the reinforcing component 140 to form a load path with good load transmission efficiency, thereby enabling better load transmission in the internal region of the vehicle structure 100, thus protecting the power unit IPU installed between the side beams 110.

The detailed structure of each component in the vehicle structure 100 will be further explained below with reference to FIG. 3A to FIG. 6.

As shown in FIG. 3A and FIG. 4, in this embodiment, the cross beam 120 has a first rib 120R1 for dividing a cross beam compartment R2 and a plurality of second ribs 120R2 connecting an upper surface S121 and a lower surface S122 of the cross beam 120, in which the first rib 120R1 extends along the vehicle length direction and the vehicle width direction, and the second ribs 120R2 extend along the vehicle height direction, that is, as shown in FIG. 3A and FIG. 4, the ribs disposed in the cross beam 120 may be formed by a combination of shapes extending along the vehicle length direction and the vehicle width direction and shapes extending along the vehicle height direction.

Furthermore, in this embodiment, the cross beam 120 includes the cross beam compartment R2 divided by any two of the first rib 120R1 in the cross beam 120 and the upper surface S121 and the lower surface S122 of the cross beam 120 extending along the vehicle width direction. Specifically, as shown in FIG. 3A, in this embodiment, the cross beam compartment R2 refers to a compartment region divided by the first rib 120R1 and the upper surface S121 of the cross beam 120, but the disclosure is not limited thereto. In other embodiments not shown, the cross beam compartment R2 may also be a compartment region divided by the first rib 120R1 and the lower surface of the cross beam 120 or a compartment region divided by the upper surface S121 and the lower surface S122 of the cross beam 120. On the other hand, as shown in FIG. 3A, in this embodiment, the reinforcing component 140 includes a reinforced component compartment R1 divided by an upper surface S141 and a lower surface S142 of the reinforcing component 140 extending along the vehicle width direction, and the channel component 130 includes a channel component compartment R3 divided by the rib 130R in the channel component 130. Furthermore, as shown in FIG. 3A, in this embodiment, the reinforced component compartment R1, the cross beam compartment R2, and the channel component compartment R3 are aligned in the vehicle height direction.

In this way, by making the heights of the reinforced component compartment R1, the cross beam compartment R2, and the channel component compartment R3 formed inside the cross-section during extrusion-forming consistent in the vehicle height direction, the upper surface S141 or the lower surface S142 of the reinforcing component 140, the upper surface S121, or the lower surface S122 of the cross beam 120, the first rib 120R1 in the cross beam 120, or the rib 130R in the channel component 130 may be used as load transmission paths. Thus, the vehicle structure 100 may form load paths with good load transmission efficiency through the disposition of the reinforced component compartment R1, the cross beam compartment R2, and the channel component compartment R3. Accordingly, even though the channel component 130 of the vehicle structure 100 forms the central channel CT and extends along the vehicle length direction, the channel component 130 may not be easily flattened and deformed by laterally input loads like the side beam 110, but may absorb impact loads when a side collision occurs and transmit loads better in the internal region of the vehicle structure 100 through the load transmission path formed through the disposition of the reinforced component compartment R1, the cross beam compartment R2, and the channel component compartment R3, thereby suppressing deformation caused by loads during side collisions.

On the other hand, as shown in FIG. 6, the reinforcing component 140 has multiple ribs 140R connecting the upper surface S141 and the lower surface S142 of the reinforcing component 140, and, referring to FIG. 4 and FIG. 6 simultaneously, in the present embodiment, at least one of the second ribs 120R2 of the cross beam 120 and at least one of the ribs 140R of the reinforcing component 140 are disposed at the same position in the vehicle length direction. Thus, through the alignment of at least one of the second ribs 120R2 of the cross beam 120 and at least one of the ribs 140R of the reinforcing component 140 in the vehicle length direction, the second ribs 120R2 of the cross beam 120 and the ribs 140R of the reinforcing component 140 may also form at least one load path with good load transmission efficiency. In this way, the ribs formed in the cross beam 120, whether extending along the horizontal direction (that is, the first ribs 120R1 extending in the vehicle length direction and vehicle width direction for dividing the cross beam compartment R2) or extending along the vertical direction (that is, the second ribs 120R2 extending in the vehicle height direction for connecting the upper surface S121 and the lower surface S122 of the cross beam 120), may form load paths with good load transmission efficiency through alignment with various portions of the reinforcing component 140, and effectively improve the efficiency of collision load transmission.

Next, referring to FIG. 3A again, in the present embodiment, the channel component 130 has a main body portion 131, an inner protrusion portion 132, and an outer protrusion portion 133, in which both the inner protrusion portion 132 and the outer protrusion portion 133 extend along the direction of the central channel CT. The inner protrusion portion 132 protrudes toward the inner side of the channel component 130 in the vehicle width direction, the outer protrusion portion 133 protrudes toward the cross beam 120, and the inner protrusion portion 132 and the outer protrusion portion 133 are integrally disposed with the main body portion 131 of the channel component 130. The vehicle structure 100 further has an inner connection portion CP1 and an outer connection portion CP2. The inner connection portion CP1 is disposed on the inner protrusion portion 132 and connected to the reinforcing component 140. The outer connection portion CP2 is disposed on the outer protrusion portion 133 and connected to the cross beam 120.

More specifically, as shown in FIG. 3A, in the present embodiment, a mounting hole FH1 is disposed at the contact portion between the inner protrusion portion 132 of the channel component 130 and the reinforcing component 140, and the inner connection portion CP1 fastens the inner protrusion portion 132 of the channel component 130 and the reinforcing component 140 in the vehicle height direction through the mounting hole FH1 with a fastener FX1. Furthermore, the contact portion between the inner protrusion portion 132 and the reinforcing component 140 may be the top or bottom of the inner protrusion portion 132 and the bottom or top of the reinforcing component 140. For example, as shown in FIG. 3A, in the present embodiment, since the inner protrusion portion 132 is disposed above the reinforcing component 140, the bottom of the inner protrusion portion 132 contacts the top of the reinforcing component 140 and has the mounting hole FH1, and the inner connection portion CP1 fastens the inner protrusion portion 132 of the channel component 130 and the reinforcing component 140 with the fastener FX1 in the vehicle height direction through the mounting hole FH1, but the disclosure is not limited thereto. As shown in FIG. 3B, in another embodiment, the inner protrusion portion 132A of the channel component 130A of another embodiment may also be disposed below the reinforcing component 140, therefore, the top of the inner protrusion portion 132A contacts the bottom of the reinforcing component 140 and has the mounting hole FH1, and the inner connection portion CP1 may also fasten the inner protrusion portion 132A of the channel component 130A and the reinforcing component 140 with the fastener FX1 in the vehicle height direction through the mounting hole FH1. Persons skilled in the art may design the position of the mounting hole FH1 according to the relative configuration position between the inner protrusion portions 132, 132A and the reinforcing component 140, as long as the inner connection portion CP1 may fasten the inner protrusion portions 132, 132A of the channel components 130, 130A and the reinforcing component 140 with the fastener FX1 in the vehicle height direction.

Thus, by integrally disposing the inner protrusion portions 132, 132A that protrude toward the direction of the central channel CT (that is, the inner side of the channel components 130, 130A in the vehicle width direction) on the channel components 130, 130A, it is possible to achieve a structure that fastens the reinforcing component 140 to the inner protrusion portions 132, 132A of the channel components 130, 130A through the configuration of the mounting hole FH1 that penetrates the reinforcing component 140 in the vehicle height direction, without requiring separate mounting components such as brackets. Moreover, by connecting the reinforcing component 140 to the inner protrusion portions 132, 132A of the channel components 130, 130A, the load input to the channel components 130, 130A may also be appropriately transmitted from the channel component 130 to the reinforcing component 140.

On the other hand, similarly, mounting holes FH2 may also be disposed at the contact portions between the outer protrusion portions 133, 133A of the channel components 130, 130A and the cross beam 120, and the outer connection portion CP2 may also fasten the outer protrusion portions 133, 133A of the channel components 130, 130A and the cross beam 120 with fasteners FX2 in the vehicle height direction through the mounting holes FH2. Specifically, as shown in FIG. 3A and FIG. 3B, the outer protrusion portions 133, 133A may also be selectively disposed on the upper surface S121 or the lower surface S122 of the cross beam 120, and the position of the mounting holes FH2 may be designed according to the relative configuration positions between the outer protrusion portions 133, 133A and the cross beam 120, as long as the outer connection portion CP2 can fasten the outer protrusion portions 133, 133A of the channel components 130, 130A and the cross beam 120 with fasteners FX2 in the vehicle height direction. Thus, by integrally disposing the outer protrusion portions 133, 133A that protrude toward the cross beam 120 on the channel components 130, 130A, it is also possible to achieve a structure that fastens the cross beam 120 to the outer protrusion portions 133, 133A of the channel components 130, 130A through the configuration of the mounting holes FH2 that penetrate the cross beam 120 in the vehicle height direction, without requiring separate mounting components such as brackets. Moreover, by connecting the cross beam 120 to the outer protrusion portions 133, 133A of the channel components 130, 130A, the load between the channel components 130, 130A and the cross beam 120 may also be appropriately transmitted.

Furthermore, as shown in FIG. 4 and FIG. 5, in the present embodiment, when viewed from a side, the upper surface S121 of the cross beam 120 has a front inclined surface FTS extending forward and tilting downward, and has a rear inclined surface BTS in a region rearward of the front inclined surface FTS in the vehicle length direction, where the rear inclined surface BTS extends rearward and tilts downward. Specifically, the cross beam 120 is formed by extrusion-forming, and thus may be made into any shape according to the application. Moreover, as shown in FIG. 4 and FIG. 5, by forming the front inclined surface FTS on the cross beam 120, the protrusion of the corner of the cross beam 120 may be reduced to make closer to a flat surface. Thus, as shown in FIG. 5, when the foot of the driver moves, the heel is also less likely to be caught by the cross beam 120, thereby improving the comfort of the foot placement or movement of the driver. On the other hand, as shown in FIG. 5, mounting portions FP for installing a seat ST or a seat bracket SB may be disposed on the rear inclined surface BTS of the cross beam 120, and through the disposition of the rear inclined surface BTS, the rear portion of the cross beam 120 may not interfere with the sliding of the seat on the seat rail, which is advantageous for the configuration and assembly of other components of the vehicle body.

Furthermore, as shown in FIG. 5 and FIG. 6, in the present embodiment, a dimension L120 of the cross beam 120 in the vehicle length direction is greater than a dimension in the vehicle height direction, and the reinforcing component 140 has a length L140 in the vehicle length direction that at least corresponds to the dimension of the cross beam 120 in the vehicle length direction. That is, in the present embodiment, the length L140 of the reinforcing component 140 in the vehicle length direction may be equal to or greater than the dimension L120 of the cross beam 120 in the vehicle length direction. Thus, the load input during a side collision may be easily transmitted from the cross beam 120 on one side through the reinforcing component 140 to the cross beam 120 on the other side.

In summary, in the embodiments of the disclosure, the vehicle structure has the cross beam and the reinforcing component disposed at overlapping positions in the vehicle height direction, the cross beam and the reinforcing component are each formed by extending in a manner of extrusion-formed along the vehicle width direction, therefore loads may be transmitted without deformation of the cross-sections of the cross beam and the reinforcing component to form a load path with good load transmission efficiency, thereby enabling better load transmission in the internal region of the vehicle structure, thus protecting the power unit installed between the side beams. Accordingly, even though the channel component of the vehicle structure forms a central channel and extends along the vehicle length direction, the channel component may not be easily flattened and deformed by laterally input loads like the side beams, but is capable of absorbing impact loads when a side collision occurs and transmitting loads better in the internal region of the vehicle structure through the load transmission path formed by the disposition of the reinforcing component, the cross beam, and the channel component, thereby suppressing deformation caused by loads during side collisions .

Finally, it should be noted that, the foregoing embodiments are merely used to illustrate the technical solutions of the disclosure, and the embodiments are not intended to limit the disclosure. Although the disclosure has been described in detail with reference to the foregoing embodiments, persons skilled in the art should understand that, they may still modify the technical solutions described in the foregoing embodiments, or make equivalent substitutions for some or all of the technical features thereof; and these modifications or substitutions do not cause the essence of the corresponding technical solutions to depart from the scope of the technical solutions of the embodiments of the disclosure.

What is claimed is:

1. A vehicle structure, comprising:
a pair of side beams; and
a channel component extending along a vehicle length direction and disposed between the pair of side beams, wherein the vehicle structure forms a central channel extends along the vehicle length direction in the channel component;
a cross beam extending along a vehicle width direction and disposed between any one of the pair of side beams and the channel component; and
a reinforcing component extending along the vehicle width direction, disposed on an inner side of the channel component in the vehicle width direction, and at a position overlapping with the cross beam in a vehicle height direction.

2. The vehicle structure according to claim 1, wherein each of the pair of side beams, the cross beam, the channel component, and the reinforcing component is an extrusion-formed product, and an extrusion direction of each of the pair of side beams, the cross beam, the channel component, and the reinforcing component is an extension direction thereof.

3. The vehicle structure according to claim 2, wherein the pair of side beams extend along the vehicle length direction, a power unit is disposed between the pair of side beams, and the channel component is disposed above the power unit.

4. The vehicle structure according to claim 2, wherein
the reinforcing component comprises a reinforced component compartment divided by an upper surface and a lower surface of the reinforcing component extending along the vehicle width direction,
the cross beam comprises a cross beam compartment divided by any two of a rib in the cross beam and an upper surface and a lower surface of the cross beam extending along the vehicle width direction,
the channel component comprises a channel component compartment divided by a rib in the channel component, and
the reinforced component compartment, the cross beam compartment, and the channel component compartment are aligned in the vehicle height direction.

5. The vehicle structure according to claim 2, wherein
the channel component has a main body portion and an inner protrusion portion, the inner protrusion portion protrudes toward the inner side of the channel component in the vehicle width direction and is integrally disposed with the main body portion of the channel component, and
the vehicle structure further has an inner connection portion disposed on the inner protrusion portion of the channel component and connected to the reinforcing component.

6. The vehicle structure according to claim 5, wherein a mounting hole is disposed at a contact portion between the inner protrusion portion of the channel component and the reinforcing component, and the inner connection portion fastens the inner protrusion portion of the channel component and the reinforcing component in the vehicle height direction through the mounting hole with a fastener.

7. The vehicle structure according to claim 2, wherein
the channel component has a main body portion and an outer protrusion portion, and the outer protrusion portion protrudes toward the cross beam and is integrally disposed with the main body portion of the channel component, and
the vehicle structure further has an outer connection portion disposed on the outer protrusion portion and connected to the cross beam.

8. The vehicle structure according to claim 2, wherein when viewed from a side, an upper surface of the cross beam has a front inclined surface extending forward and tilting downward.

9. The vehicle structure according to claim 8, wherein when viewed from a side, the cross beam has a rear inclined surface in a region rearward of the front inclined surface in the vehicle length direction, and the rear inclined surface extends rearward and tilts downward.

10. The vehicle structure according to claim 2, wherein the cross beam has a dimension in the vehicle length direction greater than a dimension in the vehicle height direction, and the reinforcing component has a length in the vehicle length direction that at least corresponds to the dimension of the cross beam in the vehicle length direction.

11. The vehicle structure according to claim 2, wherein the cross beam has a plurality of ribs connecting an upper surface and a lower surface of the cross beam, the reinforcing component has a plurality of ribs connecting an upper surface and a lower surface of the reinforcing component, and at least one of the ribs of the cross beam and at least one of the ribs of the reinforcing component are disposed at same position in the vehicle length direction.
